(19) United States
(12) Patent Application Publication
(10) Pub. No.: US 2026/0060414 A1
(43) Pub. Date: Mar. 5, 2026

(54) Collapsible Furniture Stand with Keyhole Couplings

(71) Applicant: Shawn an Dawns, LLC, Arcadia, IN (US)

(72) Inventor: Shawn Hickey, Fishers, IN (US)

(21) Appl. No.: 19/319,043

(22) Filed: Sep. 4, 2025

Related U.S. Application Data
(60) Provisional application No. 63/691,304, filed on Sep. 5, 2024.

(51) Int. Cl. A47B 3/06; F16B 12/22

(52) U.S. Cl. CPC A47B 3/06; F16B 12/22

(57) ABSTRACT

A furniture stand includes a removable horizontal base panel, a removable horizontal top panel, and a collapsible body. The collapsible body includes a front panel, a back panel, a left panel and a right panel. The panels of the body are configured to be coupled together using a post-and-keyhole arrangement wherein posts from one panel fit into keyholes in another panel. The base panel and the top panel are configured for convenient assembly on or removal from the body.

### CROSS-REFERENCE TO RELATED APPLICATIONS

The present application claims priority from U.S. Provisional Patent Application No. 63/691,304, filed Sep. 5, 2024, the entire contents of which are incorporated by reference herein.

### FIELD

The present disclosure relates to the field of furniture, and particularly to ready-to-assemble furniture products.

### BACKGROUND

Modern furniture is often sold in packages that hold unassembled furniture components that must be removed from the packaging and then assembled by the end user. Examples of such furniture can be found at any number of big box stores such as IKEA, Costco, and Walmart. Unassembled furniture is conveniently held by the seller at either a retail store where it may purchase by a customer, or at a warehouse where it is retained until it is transferred to the store or shipped to a customer. Because the furniture is sold unassembled and in a package, the footprint of the furniture is much smaller than it would be if the furniture were sold completely assembled. This saves valuable space for the both the retail store and the warehouse. Additionally, because the footprint of the furniture is smaller than assembled furniture, shipping costs are less to ship the furniture to retailers and/or customers. Moreover, because the furniture is not pre-assembled, the manufacturer saves on manufacturing costs. As a result of all of these savings, the unassembled furniture may be sold more cheaply than assembled furniture.

Unfortunately, once the unassembled furniture reaches the end customer, the customer typically finds unassembled furniture to be difficult to assemble. Customers are often frustrated with the complexity of assembly, the lack of clear instructions for assembly, the number of tools required for assembly, and the amount of time to assemble the furniture. For this reason, some customers avoid the purchase of unassembled furniture.

In view of the foregoing, it would be desirable to provide unassembled furniture that may be conveniently packaged with a small footprint, but that is easy to assemble for the customer. It would also be advantageous for the furniture to be quickly assembled without the use of tools.

### SUMMARY

In at least one embodiment disclosed herein, a furniture stand includes a horizontal base panel, a horizontal top panel, and a collapsible body including two opposing side panels, a front panel, and a back panel. All of the panels of the furniture stand are coupled together using post-and-keyhole connections. The furniture stand it packaged in a collapsed configuration with all of the panels removed from one another and lying flat/parallel relative to one another within the box/packaging. The panels are also arranged in the box such that the panels are assembled in the order in which they are removed from the box. The total thickness of the package is approximately that of the sum of the thicknesses of the two side panels, the front panel, the back panel, the base panel and the top panel, or less when two or more panels may be arranged side-by-side in the box.

In at least one embodiment, the furniture stand includes a collapsible vertical body, a horizontal base panel, and a horizontal top panel. The vertical body comprises a front panel, a back panel opposite the front panel, a left side panel, and a right side panel. The left side panel is connected to the front panel with a first post-and-keyhole arrangement and connected to the back panel with a second post-and-keyhole arrangement. The right side panel is connected to the front panel with a third post-and-keyhole arrangement and connected to the back panel with a fourth post-and-keyhole arrangement. An interior space is defined by the front panel, the back panel, the left side panel and the right side panel of the collapsible vertical body. The horizontal base panel is positioned within the interior cabinet space of the collapsible vertical body. The horizontal top panel is positioned on top of the collapsible vertical body above the interior cabinet space.

In at least one embodiment disclosed herein, a kit for a furniture stand includes a package with a vertical body, a horizontal base panel and a horizontal top panel positioned in the package. The vertical body includes a plurality of free panels arranged in parallel with one another within the package, the plurality of panels including a front panel with a plurality of key holes, a back panel with a plurality of key holes, a left side panel with a plurality of posts, and a right side panel with a plurality of posts, wherein the plurality of posts are configured to fit within the plurality of keyholes. The horizontal base panel is positioned in parallel with the plurality of free panels of the vertical body within the package. The horizontal top panel is positioned in parallel with the horizontal base panel and the plurality of interconnected panels of the vertical body within the package.

In order to assemble the furniture stand, the end user simply removes the panels from the box and sequentially couples the panels together by inserting the pins/posts on one panel into the keyholes on an adjoining panel. Specifically, the head of each pin/post is inserted into the enlarged portion of the keyhole, and then the head of the pin is slid to the bottom portion of the keyhole, thus locking the head in place within the keyhole. No tools are required for assembly of the furniture stand.

In at least one embodiment, the method comprises opening a package comprising a plurality of panels for the furniture cabinet, and then removing the plurality of panels from the package, the plurality of panels including a horizontal base panel, a horizontal top panel, and a vertical body comprised of a front panel, a back panel, a left side panel and a right side panel. Thereafter, the method includes coupling the back panel to the left side panel with a first post-and-keyhole arrangement, and coupling the back panel to the right side panel with a second post-and-keyhole arrangement. The method also comprises coupling the front panel to the left side panel with a third post-and-keyhole arrangement, and coupling the front panel to the right side panel with a fourth post-and-keyhole arrangement, wherein the front panel, the back panel, the left panel, and the right panel define an interior space. After the vertical body is assembled, the method further comprises arranging a horizontal base panel within the interior space with the horizontal base panel perpendicular to the front panel, back panel, left side panel, and right side panel. Additionally, the method comprises arranging a horizontal top panel above the interior space with the horizontal top panel perpendicular to the vertical front panel, back panel, left side panel, and right side panel.

The above described features and advantages, as well as others, will become more readily apparent to those of ordinary skill in the art by reference to the following detailed description and accompanying drawings. While it would be desirable to provide a furniture stand that provides one or more of these or other advantageous features as may be apparent to those reviewing this disclosure, the teachings disclosed herein extend to those embodiments which fall within the scope of any eventually appended claims, regardless of whether they include or accomplish one or more of the advantages or features mentioned herein.

### BRIEF DESCRIPTION OF THE DRAWINGS

FIG. 1 shows a middle front perspective view of an assembled furniture stand;

FIG. 2 shows a lower perspective side view of the furniture stand of FIG. 1;

FIG. 3 shows a front plan view of the furniture stand of FIG. 1;

FIG. 4 shows a side plan view of the body of the furniture stand of FIG. 1;

FIG. 5 shows a perspective view of a first panel with a post and a second panel with a keyhole for the furniture stand of FIG. 1;

FIG. 6 shows a perspective view of the post of the first panel being inserted into the keyhole of the second panel of FIG. 5;

FIG. 7 shows a package containing the furniture stand of FIG. 1 in a collapsed configuration;

FIG. 8 shows the panels of the package of FIG. 7 removed from the package in a collapsed configuration;

FIG. 9 shows a front panel of the furniture stand of FIG. 8 in the process of being coupled to a first side panel;

FIG. 10 shows the front panel of the furniture stand of FIG. 9 after it is coupled to the first side panel and before a second side panel is coupled to the front panel;

FIG. 11 shows the second side panel being coupled to the front panel and a back panel of the furniture stand of FIG. 10;

FIG. 12 shows a base panel being inserted into a completed body of the furniture stand of FIG. 11;

FIG. 13 shows a top panel being inserted onto the completed body of the furniture stand of FIG. 12; and

FIG. 14 shows a perspective side view of the assembled furniture stand of FIG. 13.

### DESCRIPTION

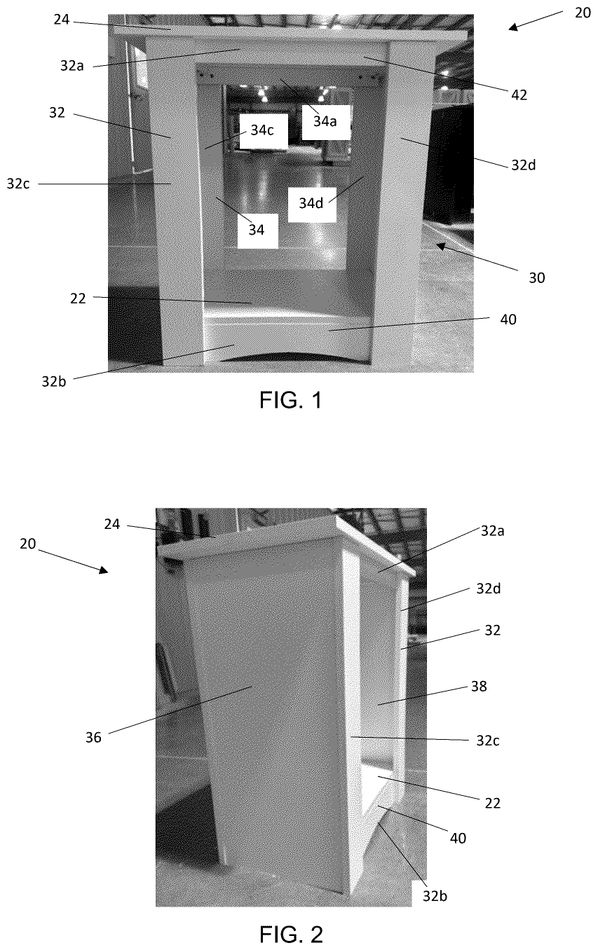

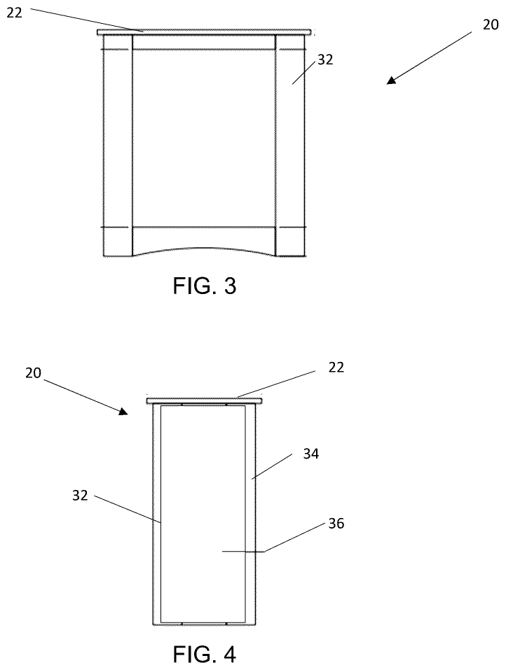

With reference to FIGS. 1-4, a furniture stand 20 is comprised of a plurality of separable panels including a horizontal base panel 22, a horizontal top panel 24, and a plurality of vertical panels that form a collapsible vertical body 30. The plurality of vertical panels include a front panel 32, a back panel 34, a left side panel 36 and a right side panel. In at least one embodiment, all of the panels 32, 34, 36, 38 of the vertical body 30 are coupled together using a post-and-keyhole arrangement, as explained in further detail herein. It will be recognized by those of ordinary skill in the art that the furniture stand described herein is of “furniture quality” which is typical for use in a modern residential or commercial setting. Structures that are “furniture quality” are typically comprised of panels and other components that are durable, strong, and aesthetically pleasing. Accordingly, it will be recognized that structures comprised of relatively thin cardboard material are not “furniture quality” structures. While the disclosure herein references a furniture stand 20, it will be recognized that a stand merely references a component configured to hold or retain another device and may alternatively be referred to as a “cabinet.”

The horizontal base panel 22 is a generally flat panel with a rectangular shape, a planar upper surface and a planar lower surface. The base panel 22 is comprised of wood, which may be, for example, a solid wood, wood veneer, plywood, particle board, or composite material. The length and width dimensions of the base panel 22 are such that it fits within the interior of the body 30 in a flat, level, horizontal position with the perimeter edges of the base panel abutting (or nearly abutting) the interior surfaces of the body 30. The base panel 22 is supported on the interior of the body 30 by bottom supports 40 provided along the lower interior surface of the front panel 32, back panel 34, and side panels 36, 38 (e.g., between the left and right sides of the front panel 32). In the embodiment of FIGS. 1-4, the bottom supports 40 are provided by the upper perimeter edge of the lower horizontal board 32b of the front panel 32 and the upper perimeter edge of the lower horizontal board 34b of the back panel 34. However, in other embodiments, the bottom supports 40 may be provided by ribs or other supports attached to an interior surface of the vertical body 30.

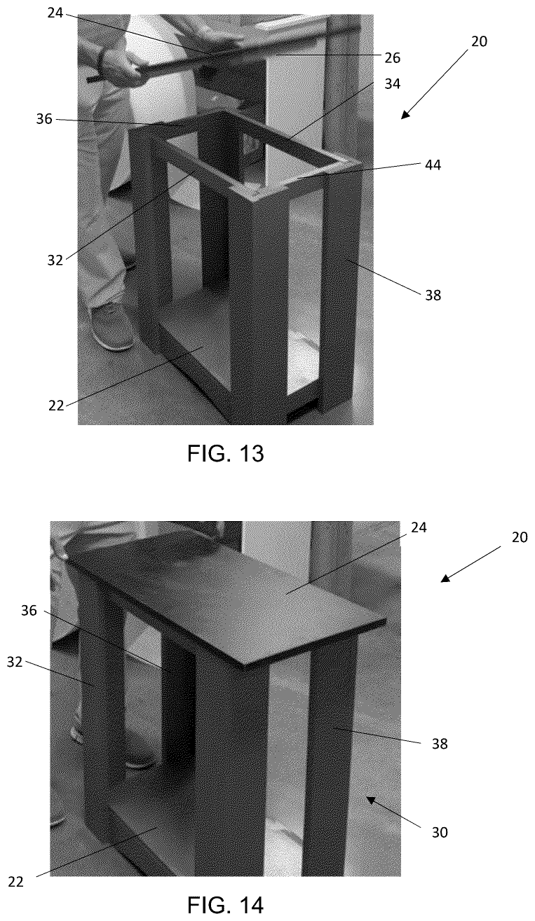

The horizontal top panel 24 is also a generally flat panel with a rectangular shape, a planar upper surface and a planar lower surface. The top panel 24 is comprised of wood, which may be, for example, a solid wood, wood veneer, plywood, particle board, or composite material. The length and width dimensions (i.e., length from front-to-back, and width from side-to-side) of the top panel 24 are greater than the length and width dimensions of the body 30. The horizontal panel 24 is thus configured to rest on supports 42 provided on the top of the body 30 which support the horizontal panel in a flat, level, horizontal position. In the embodiments disclosed herein, the top supports 42 are provided by the upper perimeter edges of the front panel 32, the back panel 34, the left side panel 36, and the right side panel 38. Because the length and width dimensions of the top panel 24 are greater than those of the body 30, a top lip of the furniture stand 20 is formed along the perimeter edges of the top panel 24. The underside of the top panel 24 includes a plurality of alignment ribs 26 (not shown in FIGS. 1-4; see FIG. 13) that extend into the interior space defined by the vertical body 30. The ribs 26 are arranged on the underside of the top panel such that they abut (or nearly abut) the front, back, left and right interior sides of the body 30. In this manner, the top panel 24 is retained in place on the body 30 and prevented from sliding along the upper surface of the body 30.

The body 30 (which may also be referred to herein as a “vertical body”) includes a front panel 32, a back panel 34, a left split side panel 36, and a right split side panel 38. Each of the panels 32-38 is vertically oriented on the furniture stand and is a generally flat panel with a rectangular shape. Each of the panels 32-38 also includes a planar inner surface and a planar outer surface. The panels 32-38 are comprised of wood, which may be, for example, a solid wood, wood veneer, plywood, particle board, or composite material. In at least one embodiment disclosed herein, at least some of the panels are formed by multiple boards that are fixedly connected together and arranged in two different panel planes, as described in further detail below.

The front panel 32 is presented on the front of the furniture stand 20 and may include one or more decorative or functional features. In the embodiment disclosed herein, the front panel 32 is a substantially open panel with a central window that provides a passage from the front to the back of the furniture stand 20. However, in at least some embodiments, the front panel 32 may be a completely closed panel and/or may include additional decorative or functional features. For example, in at least one embodiment, a door (not shown) is arranged on the front panel 32. Hinges on one side of the door allow the door to swing open and closed relative to the front panel 32. In at least one embodiment the front panel includes two horizontal boards 32a, 32b, and two vertical boards 32c, 32d (e.g., see the arrangement of FIGS. 1, 2, 9 and 10). The two horizontal boards 32a, 32b are positioned inwardly from the two vertical boards 32c, 32d on the front panel. As such, the two horizontal boards 32a, 32b lie in a different panel plane than the two vertical boards 32c, 32d (wherein each panel plane defined by a plane extending through a center of the board and parallel to the faces of the board). The ends of the boards 32a-32d are fixedly connected together (e.g., with screws or other fasteners and/or adhesives) to form a rectangular front panel 32.

Similar to the front panel 32, the back panel 34 is a substantially open panel in the embodiment disclosed herein, allowing access to the interior of the body 30 through the back panel 34. However, in at least some embodiments, the back panel 34 may be a closed panel and/or may include additional decorative or functional features. In at least one embodiment the back panel 34 includes two horizontal boards 34a, 34b, and two vertical boards 34c, 34d (e.g., see the arrangement of FIGS. 1, 2, 9 and 10. The two horizontal boards 34a, 34b are positioned inwardly from the two vertical boards 34c, 34d on the front panel. Therefore, the two horizontal boards 34a, 34b lie in a different panel plane than the two vertical boards 34c, 34d. The ends of the boards 34a-34d are fixedly connected together (e.g., with screws or other fasteners and/or adhesives) to form a rectangular back panel 34.

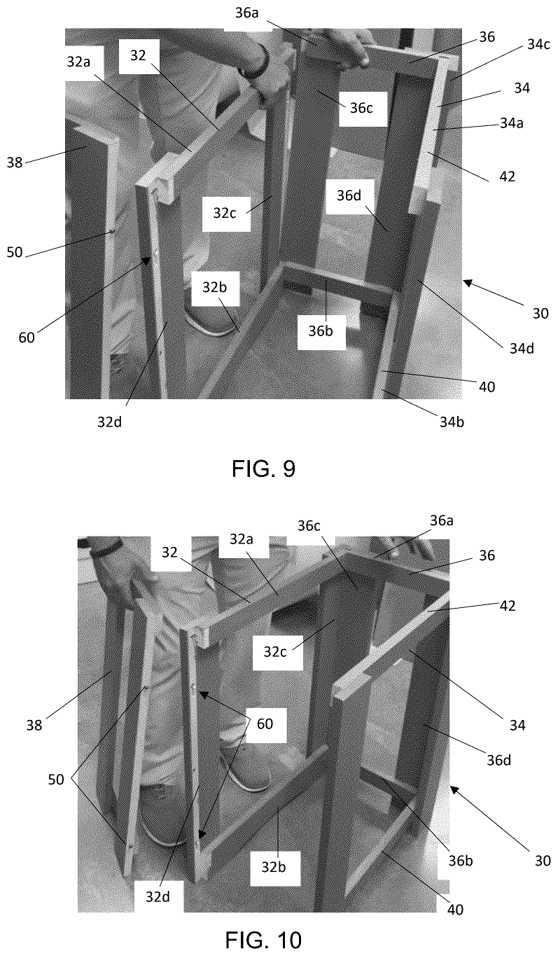

The left side panel 36 and the right side panel 38 of the body are closed panels in the embodiment of FIGS. 1-4 (but are substantially open panels in the embodiment of FIGS. 9-14). In each embodiment disclosed herein, the right side panel 38 is a symmetric copy of the left side panel 36. Accordingly, only the left side panel 36 is described in detail herein, but it will be recognized that the right side panel 38 is symmetrically identical to the left side panel 36.

In at least one embodiment the left side panel 36 is a one-piece solid board. In other embodiments, the left side panel is formed by two horizontal boards 36a, 36b, and two vertical boards 36c, 36d (e.g., see the arrangement of FIGS. 9-13). In this embodiment, the two horizontal boards 36a, 36b are positioned inwardly from the two vertical boards 36c, 36d on the front panel. Therefore, the two horizontal boards 36a, 36b lie in a different panel plane than the two vertical boards 36c, 36d. In such embodiment, the ends of the boards 36a-36d are fixedly connected together (e.g., with screws or other fasteners and/or adhesives) to form a rectangular back panel 34.

The side panels 36, 38 are coupled to the front panel 32 and the back panel 34 using a post-and-keyhole arrangement (which may alternatively be referred to as a pin-and-keyhole or key-and-keyhole arrangement). In the embodiments disclosed herein, a plurality of posts 50 extend horizontally outward from the perimeter edges of the vertical boards 36c, 36d of the left side panel 36, and similarly from the perimeter edges of the vertical boards of the right side panel 38. Keyholes 60 are arranged in the left and right sides of the rear surface of the front panel 32, and in the left and right sides of the front surface of the back panel 34. When the front panel 32 and back panel 34 are formed of multiple boards in different panel planes, the keyholes 60 are arranged in the rear surface of the left vertical and right vertical boards 32c, 32d of the front panel 32, and in the front surface of the left and right vertical boards of the back panel 34.

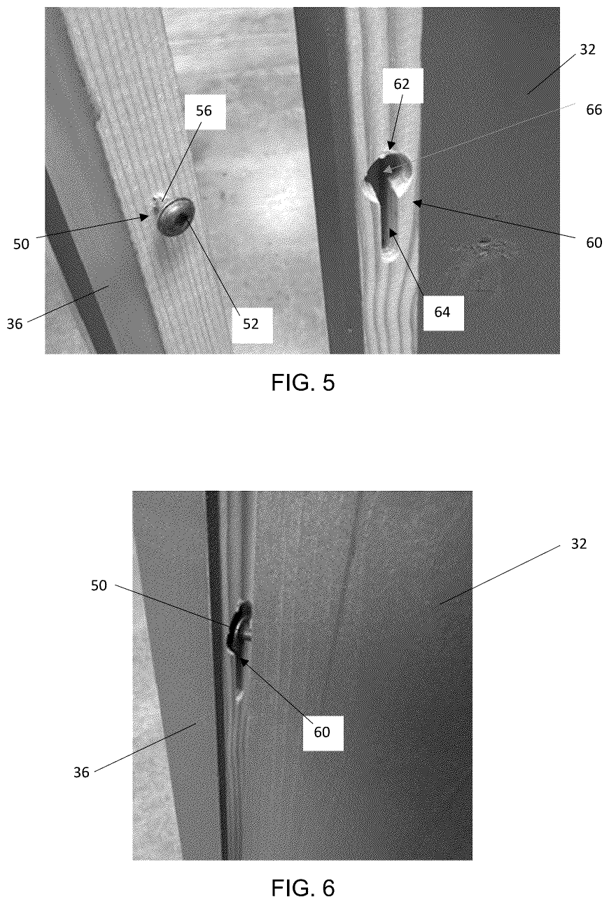

With reference now to FIGS. 5 and 6, a post-and-keyhole arrangement is illustrated wherein the side panels 36, 38 include a plurality of posts 50 that extend horizontally outward from vertical edges/sides of the panels, and the front panel 32 and back panel 34 include a plurality of keyholes 60 configured to receive the posts 50. The posts are positioned directly opposite one another on each side panel such that when a post extends horizontally in the forward direction on one of the side panels another post extends horizontally in the rearward direction on the side panel. Each vertical edge of the side panel 36, 38 includes one post located near an upper end of the panel and another post located near a lower end of the panel.

Each post 50 includes an enlarged head 52 and a relatively narrow and elongated pin 56. The head 52 may include a central slot (e.g., a slot configured to receive an Allen wrench or a Phillips head screwdriver) that is used to rotate and drive the post into the panel. The pin 56 may be threaded (e.g., may have the form of a screw or bolt), thus allowing the pin 56 to be securely retained by the wood or other material of the panel. In at least some embodiments, the posts 50 are pre-installed on the vertical perimeter edges of the side panels 36, 38.

Each keyhole 60 includes an enlarged upper opening 62 and an elongated narrow opening 64 that is downwardly extending on the panel. The enlarged upper opening 62 is sufficiently sized to receive the head 52 of a post. The narrow opening 64 is sufficiently wide to allow the pin 56 of a post 50 to slide along the narrow opening 64 but is also sufficiently narrow to prevent the head 52 of the post 50 to pass through the narrow opening 64. A cavity 66 is formed behind the enlarged upper opening 62 and the elongated narrow opening that is sufficiently sized to contain the head 52 of the post 50. In the embodiments disclosed herein, the keyholes 60 are arranged on the rear surface of opposing sides of the front panel 32 with at least one keyhole near the top and one keyhole near the bottom of each side of the panel. As noted previously, when the front panel is comprised of a plurality of boards in different panel planes, the keyholes 60 are arranged on the rear surface of the vertical boards 32c, 32d. Similarly, the keyholes 60 are also arranged on the front surface of opposing sides of the back panel 34 with at least one keyhole near the top and one keyhole near the bottom of each side of the back panel 34. As noted previously, when the back panel is comprised of a plurality of boards in different panel planes, the keyholes 60 are arranged on the front surface of the vertical boards 34c, 34d.

As specifically shown in FIG. 6, in order to couple one panel to another, the posts 50 of one panel are configured to be received within the keyholes 60 of another panel. In particular, in order to couple a first panel to a second panel, the heads 52 on the posts 50 of the first panel are inserted into the complementary enlarged openings 62 of the keyholes 60 of the second panel. Then, the pins 56 of the posts 50 are slid downwardly (i.e., away from the enlarged openings 62) along the narrow openings 64. When the pins 56 of the posts 50 are moved away from the enlarged openings 62, the posts 50 are locked in place in the keyholes 60 (i.e., the posts 50 are prevented from any movement other than the ability to slide back toward the enlarged openings 62 of the keyholes, which typically requires a vertical movement that opposes the force of gravity). In this manner, a first panel of the body 30 may be coupled to a second panel of the body.

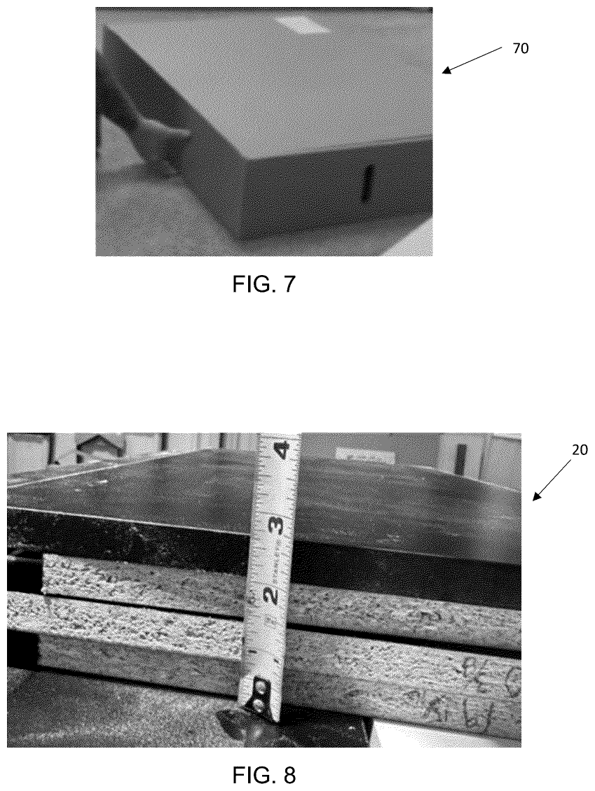

With reference now to FIGS. 7 and 8, it will be recognized that the furniture stand 20 is configured to be easily assembled and disassembled using the post-and-keyhole couplings between the panels of the body 30. When in the collapsed configuration, all of the panels 22, 24, and 32-38 are separate from one another and may be arranged parallel within a package 70 (e.g., a box as shown in FIG. 7). Because the panels are separated from one another within the package, each panel may be considered a “free panel” when the furniture stand 20 is in the disassembled configuration. The package 70 may be any appropriate package for storage, containment and shipment of furniture-quality merchandise, such as a cardboard container with foam or plastic inserts for padding, or other appropriate packaging as will be recognized by those of ordinary skill in the art.

In the embodiment disclosed herein, each free panel of the vertical body 30 and/or board of the front panel 32 and back panel 34 is defined by six faces including two larger faces, and four narrow elongated perimeter faces (which may also be referred to herein as “perimeter edges”). When placed in the package 70, at least one of the two larger faces of each panel engages one of the two larger faces of an adjacent panel within the package 70 (i.e., either directly or by a small separation with foam or other padding therebetween). Because of the unique design of the components of the furniture cabinet, a user who purchases the kit may assemble the furniture cabinet 20 without the use of tools.

Because one configuration of the furniture stand 20 is a disassembled configuration with an associated package 70, it will be appreciated by those of ordinary skill in the art that a “kit” for a furniture stand is disclosed herein. The disclosed kit includes all of the panels 22, 24, and 32-38 arranged in a relatively compact package 70 wherein all of the panels are stacked upon one another in a planar manner within the package, and the total depth of the package is only slightly more than the combined thicknesses of the base panel 22, top panel 24, front panel 32, back panel 34, left side panel 36, and right side panel 38. For example, if the thickness of each panel is 0.75 inches (e.g., the distance between the front surface and the rear surface of the front panel 32 is 0.75 inches), the total depth of the package may be only slightly more than 4.5 inches when all panels of the furniture stand are arranged in the package (i.e., 0.75 inches/panel×6 panels=4.5 inches). In at least some embodiments, the size of the base panel 22 or top panel 24 is such that these panels may be arranged in the package side-by-side, next to one of the two side panels 36, 38), and/or within an opening in the front panel 32 or back panel 34, if available. Moreover, when one or more of the panels 32, 34, 36, 38 are formed by multiple elongated boards arranged in different panel planes, the panels may be offset or arranged within one another such that at least some boards on different panels are arranged in the same panel plane within the package 70. In these embodiments, the thickness of the package may be less than the combined thicknesses of the base panel 22, top panel 24, front panel 32, back panel 34, left side panel 36, and right side panel 38.

With reference now to FIGS. 9-14, a method of assembly (and disassembly) of the furniture stand 20 is shown. The method begins with panels of the furniture stand 20 being removed from the package (e.g., the box 70 shown in FIG. 7). In at least one embodiment, the panels are retained within the package such that the user removes the panel in the order in which the panels are to be assembled, as indicated on an instruction sheet retained within the package (or on an instruction website accessed using a QR code provided with the package).

FIG. 9 shows the panels of the body 30 removed from the package with the left side panel 36 already coupled to the back panel 34, and the front panel 32 in the process of being coupled to the left side panel 36. As noted previously, the front panel 32 is coupled to the left side panel 36 by inserting the posts on the left side panel 36 into keyholes on the left side panel 36 and then sliding the left side panel 36 downward such that the posts fully engage the keyholes.

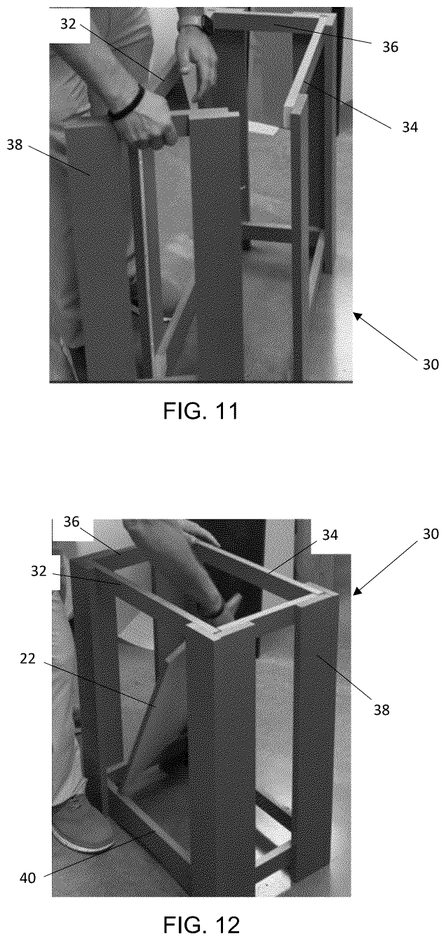

Next, as shown in FIGS. 10 and 11, the right side panel 38 is coupled to the front panel 32 and the back panel 34. Again, this is accomplished by inserting the posts 50 on the right side panel 38 into keyholes 60 on the front panel 32 and the back panel 34, and sliding the right side panel 38 downward such that the posts 50 fully engage the keyholes 60 (i.e., the heads 52 of the posts 50 are seated at the bottom of the cavity 66 behind the narrow openings 64). Once the right side panel 38 is coupled to the front panel 32 and the back panel 34, the body 30 of the furniture stand 20 is assembled.

After the body 30 of the furniture stand 20 is formed, the next step in the assembly process is to insert the base panel 22 into the bottom of the body 30, as shown in FIG. 12. When the base panel 22 is placed into the bottom of the body 30, the base panel 22 rests on the lower supports 40.

Next, as shown in FIG. 13, the top panel 24 is place on top of the body 30. This is accomplished by inserting the ribs 26 on the lower side of the top panel 24 into the interior volume of the body 30 such that the ribs abut two or more of the body panels, and the top panel 24 rests on the upper supports 44. In the embodiments disclosed herein, the upper supports 44 are provided by the top perimeter edges of each panel of the vertical body 30, including the top perimeter edges of the front panel 32, the back panel 34, the right side panel 36, and the left side panel 38.

The fully assembled furniture stand 20 is shown in FIG. 14. As illustrated in FIGS. 7-14, the furniture stand 20 may be removed from the packaging and assembled in a very short period of time (e.g., within one minute) and does not require the use of tools or fasteners. The simple upright nature of the furniture stand 20 with the vertical panels 32-38 of the body supporting the horizontal top panel 24 makes the furniture stand 20 very strong and capable of holding significant weight. For example, depending on the particular embodiment of the furniture stand, the furniture stand is very strong and configured to hold hundreds of pounds or more of weight on the top panel 24. This makes the furniture stand ideal for retaining heavy objects that are to be displayed in a home or business, such as large aquariums that hold dozens or even hundreds of gallons of water.

In addition to holding significant weight, the furniture stand is also decorative and functional. For example, the furniture stand may be displayed publicly as a unique piece of furniture. In at least some embodiments, a door may be provided on the front of the furniture stand, making the furniture stand a cabinet with the door allowing a user to access the interior of the body 30 of the furniture stand.

In addition to the foregoing embodiments of the furniture stand 20, it will be recognized that numerous additional embodiments are also contemplated. For example, the furniture stand may be configured in different sizes and shapes and may include any number of additional decorative or functional features. The design can be used across a wide range of sizes-current designs range from a small stand of 20 inches wide to a large stand of 72 inches wide. The collapsible design fits well with applications where the furniture stand will be moved.

In view of the foregoing, it will be recognized that a decorative furniture stand is disclosed herein for displaying large and/or heavy objects. One application for the furniture stand 20 is to hold television or other media. Another application is for the furniture stand to hold and display fish tank aquariums. In at least some embodiments, the furniture stand can securely hold 1,500 lbs. of weight. The collapsible design of the body allows it to be easily assembled or disassembled. The compact design of the collapsed stand is convenient for transportation and storage (for the consumer in their home, for the retailer in their store, for the distributor in their warehouse). The convenient post-and-keyhole couplings allow all the parts to fit together in their correct location with no tools required to assemble (or disassemble) the stand. This is in contrast to current designs on market use hardware and require tools for assembly.

In at least one embodiment, only some of the panels of the collapsible furniture stand 20 are free from the other panels. For example, the furniture stand 20 may combine the post-and-keyhole arrangement disclosed herein with other means for coupling panels. In at least one embodiment, the front panel 32 is connected to the left side panel 36 and the right side panel 38 using a post-and-keyhole arrangement, but the back panel 34 (or the front panel 32) is connected to the left side panel 36 and the right side panel 38 using hinges, such as those disclosed in U.S. patent application Ser. No. 19/318,644, filed Sep. 4, 2025, filed Sep. 4, 2025, the entire contents of which are incorporated by reference herein. Such embodiment may be particularly advantageous when the length/depth of each side panel 36, 38 is less than half the length/width of the back panel 38 (and/or the front panel 32). In such embodiment, the side panels 36, 38 may be folded inwardly along the hinges when the furniture stand 20 is placed in the collapsed configuration and arranged in the package 70 with the side panels 36, 38 in parallel with the back panel 34 (and the front panel 32). Then, when removed from the package 70, the side panels 36, 38 may be unfolded outwardly and placed in a plane that is perpendicular to the back panel 34 (or the front panel 32). Thereafter, the post-and-keyhole arrangement may be used to connect the side panels 36, 38 to the front panel 32 (or the back panel 34). In at least one further embodiment, the base panel 22 is also hingedly connected to the front panel 32 (or the back panel), similar to that described in the above-referenced U.S. patent application Ser. No. 19/318,644, filed Sep. 4, 2025. In this embodiment, when the vertical body 30 is assembled (i.e., with the side panels 36, 38 perpendicular with and connected to the front panel 32 and back panel 34), the hinged base panel 22 may simply be rotated downwardly until it engages the lower board (or a support rib or other ledge) of the back panel 32. Thereafter, the free top panel may be placed on the vertical body to complete the furniture stand.

Although the various embodiments of a furniture stand have been provided herein, it will be appreciated by those of skill in the art that other implementations and adaptations are possible. For example, while two different sizes and configurations of the furniture stand are disclosed herein, it will be recognized that numerous different sizes and configurations of the furniture stand are possible. In at least some embodiments, additional decorative or functional features may also be included on the panels. In yet other embodiments, the panels may be comprised of a non-wood material, such as a metal or plastic material. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed is:

1. A furniture stand comprising:
a collapsible vertical body including:
a front panel,
a back panel opposite the front panel,
a left side panel connected to the front panel with a first post-and-keyhole arrangement and connected to the back panel with a second post-and-keyhole arrangement, and
a right side panel connected to the front panel with a third post-and-keyhole arrangement and connected to the back panel with a fourth post-and-keyhole arrangement,
wherein an interior space is defined by the front panel, the back panel, the left side panel and the right side panel of the collapsible vertical body;
a horizontal base panel positioned within the interior space of the collapsible vertical body; and
a horizontal top panel positioned on top of the collapsible vertical body above the interior space.

2. The furniture stand of claim 1 wherein the horizontal top panel is removable from the collapsible vertical body, the horizontal top panel further comprising a plurality of alignment ribs positioned on a bottom side of the horizontal top panel and arranged within the interior space with at least one of the plurality of alignment ribs abutting an interior surface of the collapsible vertical body.

3. The furniture stand of claim 1, the collapsible vertical body further comprising a plurality of support ribs positioned within the interior space with the horizontal base panel resting on the plurality of support ribs.

4. The furniture stand of claim 3, wherein the horizontal base panel is removably positioned within the interior space.

5. The furniture stand of claim 1 wherein the horizontal base panel is hingedly connected to an interior surface of the collapsible vertical body within the interior space.

6. The furniture stand of claim 5 wherein the front panel includes at least two elongated horizontal boards connected to and positioned rearward from at least two elongated vertical boards, and wherein the back panel includes at least two elongated horizontal boards connected to and positioned forward from at least two elongated vertical boards.

7. The furniture stand of claim 6 wherein keyholes are positioned in the at least two elongated vertical boards of the front panel and in the at least two elongated vertical boards of the back panel, wherein a first post extends forward from a perimeter edge of the left side panel and into one of the keyholes in the front panel, wherein a second post extends rearward from a perimeter edge of the left side panel and into one of the keyholes in the back panel, wherein a third post extends forward from a perimeter edge of the right side panel and into one of the keyholes in the front panel, wherein a fourth post extends rearward from a perimeter edge of the right side panel and into one of the keyholes in the back panel.

8. A kit for a furniture stand comprising:
a package;
a vertical body positioned in the package, the vertical body comprising a plurality of free panels arranged in parallel with one another within the package, the plurality of panels including a front panel with a plurality of keyholes, a back panel with a plurality of keyholes, a left side panel with a plurality of posts, and a right side panel with a plurality of posts, wherein the plurality of posts are configured to fit within the plurality of keyholes;
a horizontal base panel positioned in parallel with the plurality of free panels of the vertical body within the package; and
a horizontal top panel positioned in parallel with the horizontal base panel and the plurality of free panels of the vertical body within the package.

9. The kit of claim 8 wherein the horizontal base panel is hingedly connected to the front panel or the back panel within the package.

10. The kit of claim 8 wherein the front panel includes at least two elongated horizontal boards connected to and positioned rearward from at least two elongated vertical boards, and wherein the back panel includes at least two elongated horizontal boards connected to and positioned forward from at least two elongated vertical boards.

11. The kit of claim 10 wherein keyholes are positioned in the at least two elongated vertical boards of the front panel and in the at least two elongated vertical boards of the back panel, wherein a first post extends forward from a perimeter edge of the left side panel and a second post extends rearward from a perimeter edge of the left side panel, and wherein a third post extends forward from a perimeter edge of the right side panel and a fourth post extends rearward from a perimeter edge of the right side panel.

12. The kit of claim 11 wherein the horizontal base panel is hingedly connected to the at least two elongated vertical boards of the back panel.

13. The kit of claim 8 wherein the horizontal base panel and the horizontal top panel are free panels within the package.

14. The kit of claim 8 wherein each panel of the plurality of free panels of the vertical body includes six faces with two larger faces, wherein at least one of the two larger faces of each panel engages one of the two larger faces of an adjacent panel within the package.

15. A method of making a furniture stand comprising:
opening a package comprising a plurality of panels for the furniture stand;
removing the plurality of panels from the package, the plurality of panels including a horizontal base panel, a horizontal top panel, and a vertical body comprised of a front panel, a back panel, a left side panel and a right side panel;
coupling the back panel to the left side panel with a first post-and-keyhole arrangement;
coupling the back panel to the right side panel with a second post-and-keyhole arrangement;
coupling the front panel to the left side panel with a third post-and-keyhole arrangement;
coupling the front panel to the right side panel with a fourth post-and-keyhole arrangement, wherein the front panel, the back panel, the left panel, and the right panel define an interior space;
arranging a horizontal base panel within the interior space with the horizontal base panel perpendicular to the front panel, back panel, left side panel, and right side panel; and
arranging a horizontal top panel above the interior space with the horizontal top panel perpendicular to the vertical front panel, back panel, left side panel, and right side panel.

16. The method of claim 15 wherein coupling the left side panel to the back panel includes inserting a first plurality of posts extending from the left side panel into a first plurality of keyholes of the back panel, and wherein coupling the right side panel to the back panel includes inserting a second plurality of posts extending from the right side panel into a second plurality of keyholes in the back panel.

17. The method of claim 16 wherein arranging the horizontal base panel within the interior space includes positioning the horizontal base panel on at least one ledge within the interior space.

18. The method of claim 17 wherein the horizontal base panel is hingedly connected to one of the back panel and the front panel.

19. The method of claim 16 wherein arranging the horizontal top panel above the interior space includes inserting ribs on a bottom surface of the horizontal top panel into the interior space and resting the bottom surface of the horizontal top panel on upper perimeter edges of the front panel, back panel, left side panel, and right side panel.

20. The method of claim 16 wherein coupling the back panel to the left side panel with a first post-and-keyhole arrangement includes inserting a head of the post into an enlarged upper opening of the keyhole and sliding a pin of the post along an elongated narrow opening of the keyhole.
